(19) United States
(12) Patent Application Publication
(10) Pub. No.: US 2008/0098909 A1
(43) Pub. Date: May 1, 2008

(54) Split marine trash compactor system

(76) Inventor: Martin A. Willamor, Theodore, AL (US)

Correspondence Address: MCNAIR LAW FIRM, P.A., P.O. BOX 10827, GREENVILLE, SC, 29603-0827, US

(21) Appl. No.: 11/529,079

(22) Filed: Sep. 28, 2006

(51) Int. Cl. B30B 1/23

(52) U.S. Cl. 100/269.01

(57) ABSTRACT

A split-trash compacting system for a vessel having a plurality of compartments comprising a trash compacting assembly disposed in a first compartment of the vessel readily accessible to persons on the vessel for receiving and compacting trash. At least one fluid actuator unit is provided for forcing the compacting head downward into a trash bin for compacting trash during a compaction cycle and retracting the compacting head during a retraction cycle. A fluid actuating assembly is disposed in a second compartment of the vessel remote from the trash compacting assembly for supplying pressurized fluid to the trash compacting assembly for actuating the fluid actuator unit. At least one fluid line connecting the fluid actuator in the first compartment and the fluid actuating assembly in the second compartment.

### FIELD OF THE INVENTION

This invention relates to a marine trash compactor and, more particularly, to a split fluid trash compactor system having a large capacity yet requires a minimum of space on a vessel.

### BACKGROUND OF THE INVENTION

With offshore boating and sports fishing becoming more and more popular, the problem of daily living on such vessels has presented a problem with trash disposal. It is not unusual for pleasure boats, and commercial and sports fishing boats, to remain offshore for several days without trash removal. Typically trash is packed in plastic bags and thrown in the engine compartment. However, large amounts of trash are produced on such boats making trash storage in the engine compartment unsafe and inconvenient when trying to work in the engine compartment. Kitchen trash compactors are not suitable onboard such boats because of inadequate capacity and the requirement of electrical power which is sometimes not only inconvenient, but unsafe in boat applications. In particular, sparks from electrical switching needed on the conventional trash compactor are dangerous in a boat environment. Domestic trash compactors are typically gear driven and noisy.

Hydraulic trash compactors are known which do not require conventional electrical power, but these units are typically too large and too cumbersome for vessel use. For example, U.S. Pat. No. 6,701,832 discloses a trash compactor for high traffic public areas having hydraulic means to compact trash. U.S. Pat. No. 6,640,701 discloses a trash compactor for use on a passenger transportation vehicle having a liquid drain for draining compressed liquids from containers during the process. U.S. Pat. No. 6,035,776 discloses a refuse and grinding system for use on a vessel or offshore platform using a hydraulic or compressed air compactor. U.S. Pat. Nos. 5,465,660 and 5,490,455 disclose aircraft trash compactors using electrical power. U.S. Pat. No. 4,620,479 discloses a hydraulic, aircraft trash compactor enclosed in a housing wherein hydraulic pump is enclosed in the housing also.

Generally, the prior art has not provided a trash compactor assembly having adequate capacity and safety, yet may be used in a relatively small space on board a boat or vessel.

Accordingly, an object of the present invention is to provide a trash compactor for a transport vehicle, such as a pleasure boat, sport fishing boat, or commercial fishing boat, and the like, which may be located in the galley or other location on board the boat conveniently accessible by passengers in a minimum space and which is safe and effective in handling the large amounts of trash produced on such vessels.

Another object of the present invention is to provide a hydraulic trash compactor for a pleasure, sports fishing, and/or commercial fishing boat having a split trash compacting assembly and fluid actuating assembly disposed in separate locations so that the trash compacting assembly may have a large capacity in a small space.

Still another object of the present invention is to provide a split trash compacting system wherein AC electrical power is not required and only a low voltage control switch is necessary for operating the compactor to avoid the dangers of high voltage sparks and the like.

### SUMMARY OF THE INVENTION

The above objectives are accomplished according to the present invention by providing a split-trash compactor system for a vessel comprising a trash compacting assembly disposed in a first area of the vessel readily accessible to persons for receiving and compacting trash. The trash compacting assembly includes a trash bin for receiving trash, and a reciprocating compacting head carried above the trash bin for compacting trash in the bin. At least one fluid actuator unit is provided for forcing the compacting head downward into the trash bin for compacting trash during a compaction cycle and retracting the compacting head to a position above the trash bin during a retraction cycle. A fluid actuating assembly disposed in a second area of the vessel remote from the first area supplies pressurized fluid to the trash compacting assembly to actuate the fluid actuator unit; and at least one fluid line connecting the fluid actuator in the first area and the fluid actuating assembly in the remote second area. A fluid control circuit is provided for controlling flow in the fluid line to reciprocate the compacting head during the compaction cycle and retraction cycle.

Preferably, the compacting assembly is located in a first compartment that includes an interior cabin area or an exterior deck area of the vessel; and the actuating assembly is located in a second compartment remote and generally isolated for noise protection. The fluid control circuit may include an electrical control unit located at the fluid actuating system for controlling a cycle control valve and delivery/return valves connected in the fluid control circuit. Advantageously, a low voltage control switch is disposed at the first location and is operatively connected with the fluid control circuit for controlling the operation of the trash compacting assembly in the first compartment. A low voltage control line connects the switch at the first compartment to the fluid actuating assembly at the second compartment. A pressure switch is operatively connected with the fluid control circuit for switching the fluid actuating assembly from the compaction cycle to the retraction cycle upon sensing a preset pressure level in the fluid line. A timer switch is operatively connected with the fluid control circuit for controlling the operation of the fluid pump wherein the timer switch reverses the operation of the trash compacting assembly from a compaction cycle to a retraction cycle after a predetermined period of time.

In another aspect of the invention, a method of disposing of trash onboard a mobile transport vehicle comprises providing a trash compacting assembly at a first location readily accessible to persons on the vehicle for receiving and compacting trash wherein the trash compacting assembly includes a trash bin for receiving trash, and a reciprocating compacting head having a fluid actuator for compacting trash in the trash bin.

Next, a fluid actuating assembly is disposed in a second, generally isolated location remote from the trash compacting assembly for supplying pressurized fluid to the fluid actuator unit. The method comprises connecting the fluid actuator in the first location and the fluid actuating assembly in the second location with at least one fluid line; and causing a fluid flow in the fluid line to reciprocate the compacting head in compaction and retraction cycles for compacting trash on board the vessel.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of a vessel having a split trash compactor system according to the invention;

FIG. 2 is a perspective of the compactor assembly of the compactor system which is disposed, for example, in the galley of the vessel; and,

FIG. 3 is a hydraulic circuit diagram of a split trash compactor system according to the invention.

### DESCRIPTION OF A PREFERRED EMBODIMENT

Referring now in more detail to the drawings, the invention will now be described in more detail.

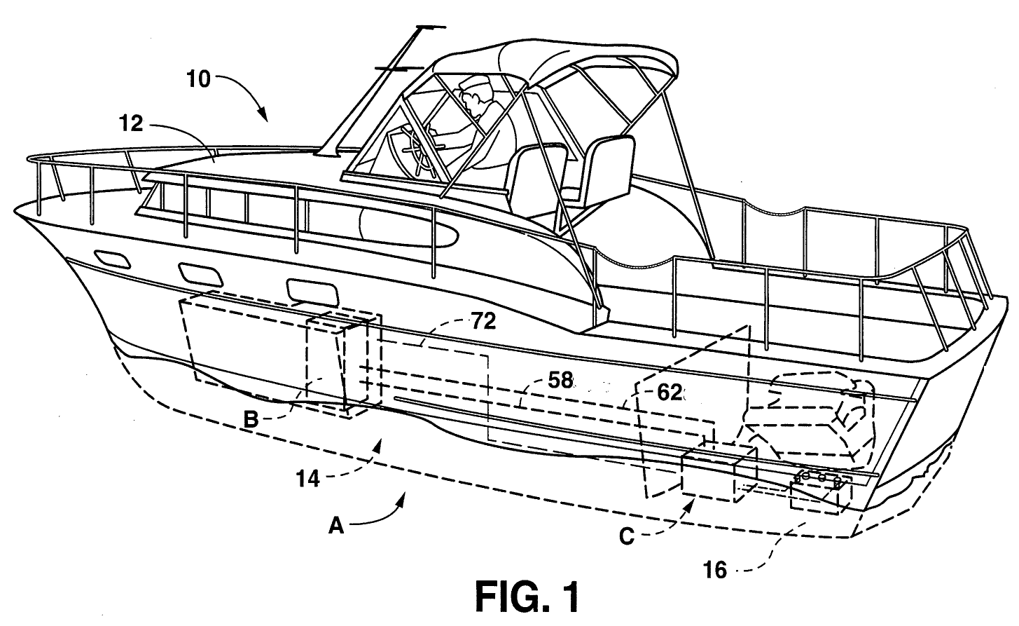

As can best be seen in FIG. 1, a vessel, designated generally as 10 is illustrated, having a cabin 12 with a galley 14. A split trash compactor system, designated generally as A, is illustrated which includes a trash compacting assembly, designated generally as B, disposed at a location in a first area on the vessel, and a fluid actuating assembly C disposed at a location in a second area of the vessel remote from the first area and the compacting subassembly. For example, in a vessel having multiple compartments, the trash compacting assembly may be located in an easily accessible cabin area such as galley 14 or a deck area, and the fluid actuating assembly may be located an engine compartment 16 or other generally isolated area for sound protection and the like.

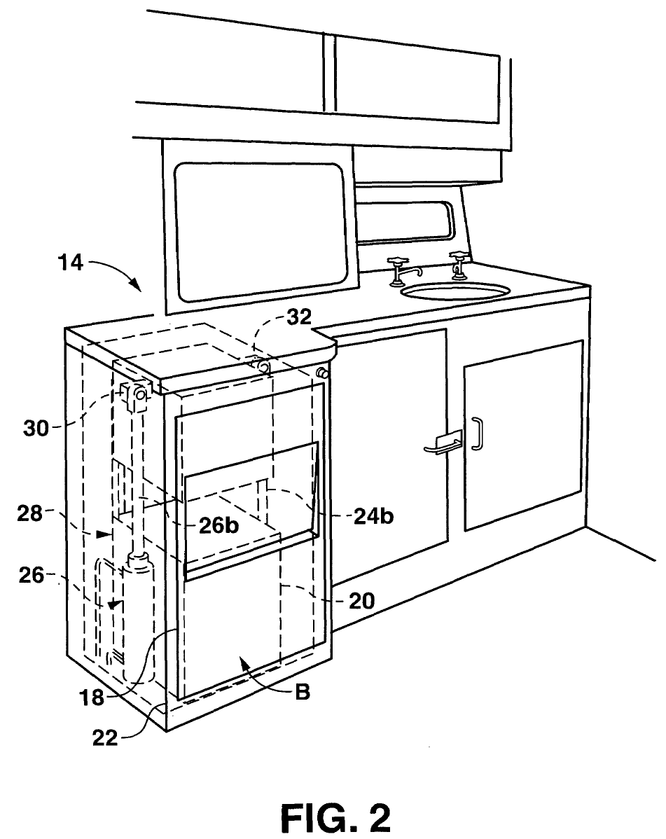

As can best be seen in FIG. 2, trash compacting assembly B includes a drawer 18 having a trash bin 20 for receiving trash. Drawer 18 may be provided with a track that allows the drawer to slide in and out of a cabinet housing 22. When the drawer is pushed in, trash bin 20 is aligned with a compacting head 25 receivable in trash bin 20 for compacting trash therein. At least one fluid actuator unit is provided for moving the compacting head to compact trash. Preferably, a pair of fluid actuator units 24, 26 are carried on opposing sides of trash bin 20 by a frame 28 of the trash compacting assembly. As the details of such a frame are known to those skilled in the art, the details of the frame are omitted. Fluid actuator unit 24 includes a cylinder 24a, a piston rod 24b, and a piston head 24c carried on its end that reciprocates in the cylinder. In like manner, fluid actuator unit 26 includes a cylinder 26a, a piston rod 26b, and a piston head 26c. Further, cylinder 24a includes an inlet port 24d and an outlet port 24e, and cylinder 26a includes an inlet port 26d and an outlet port 26e. The upper ends of piston rods 26b and 24b are attached to blocks 30 and 32 affixed to compacting head 25. In this manner, fluid entering the fluid actuator units 24 and 26 moves the compacting head up and down. A trip switch 34 is carried by compacting head 25 which is tripped by engaging an upper edge 36 of trash bin 20 upon reaching a lowermost position of travel during the compaction cycle in the event the bin is relatively empty.

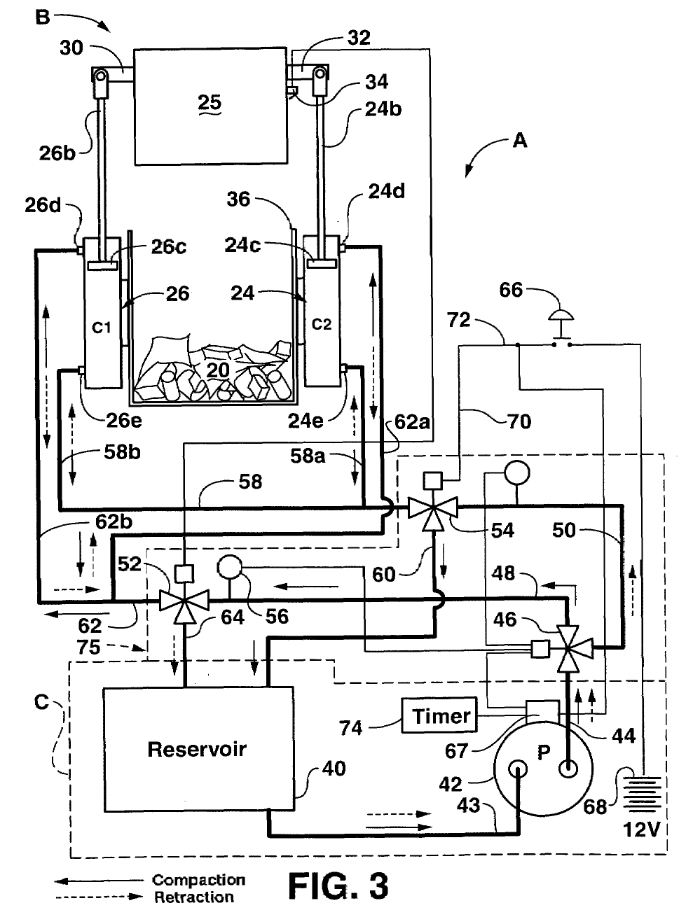

As can best be seen in FIG. 3, fluid actuating assembly C includes a fluid reservoir 40 and a fluid pump 42 connected by a supply line 43. In the illustrated example, the fluid system may be hydraulic fluid, but it is to be understood that the system may also be a gas, such as compressed air, rather than a liquid actuating system. A fluid control circuit includes a discharge line 44 connected to a three-way, cycle control valve 46. A first discharge line 48 is connected to one outlet of valve 46 and a second discharge line 50 is connected to a second outlet of valve 46. Discharge line 48 is connected to a second three-way, delivery/return valve 52 and main line 50 is connected to a third three-way, delivery/return valve 54. The three-way valves are normally open. Three-way valves 46, 52, and 54 may be any suitable electromechanical flow control device such as conventional solenoid, servo, or motor driven valves.

A pressure switch 56 is connected to a discharge line 48. A first delivery line 58 is connected to a first outlet of valve 54 and a return line 60 is connected to a second outlet of valve 54 terminating in reservoir 40. Delivery line 58 includes a branch line 58a connected to retraction port 24e of fluid actuator unit 24 and a second branch line 58b connected to retraction port 26e of fluid actuator unit 26. A second delivery line 62 is connected to a first outlet of valve 52 and a return line 64 is connected to a second outlet of valve 52 terminating at reservoir 40. Delivery line 62 includes a pair of branches 62a and 62b. Branch line 62a is connected to compaction port 24d of fluid actuator unit 24. Branch line 62b is connected to compaction port 26d of fluid actuator unit 26. A low voltage switch 66 is connected to valve 54 for actuating the valve, and loss voltage power source 68.

An electrical control unit 75 is provided by the electrical actuators of electromechanical control valves 46, 52, 54; low voltage control switch 66; pressure switches 56, 61; timer switch 74; and trip switch 34 for controlling fluid flow.

In operation, when switch 66 is depressed, a low power electrical signal 70 (e.g. 12 volts) is sent to valve 54, and to a motor 67 of fluid pump 42. The low power signal actuates valve 54 to close delivery line 58 and switches the pump to establish line voltage (e.g. 115 A/C) to the pump. Pressurized fluid is delivered from the pump along discharge line 48 through valve 52, through branch lines 62a and 62b to the compaction ports of cylinders 24 and 26. This pressurized fluid forces the piston heads 24c, 26c down causing compacting head 25 to compact the trash in bin 20. The pressure switch signal actuates valve 54 to block discharge line 50 and place delivery line 58 in communication with return line 60. Displaced fluid flows back through branch lines 58a and 58b to valve 54, returning to reservoir 40 through return line 60. If there is little trash in bin 20, trip switch 34 may engage the upper edge 36 of the bin on the compacting stroke. When switch 34 is tripped, a low voltage signal is sent to valve 52 thereby actuating the valve and connecting delivery line 62 to the reservoir line 64 via valve 52 relieving the compaction cycle. A timer 70 will reverse the cycles by actuating valve 46 to deliver pressurized fluid through delivery line 50 and valve 54 to retraction ports 24e, 26e via branch lines 58a, 58b. This causes the compaction head to retract. At the same time, compaction fluid is returned through compaction ports 24d, 26d via line branches 62a, 62b to reservoir 40 through valve 52.

When there is sufficient trash in bin 20 to build up higher pressure in delivery line 48 during a compaction cycle, this pressure will be read by a pressure switch 56 which is preset to actuate valve 46 and reverse the cycles upon reaching a pre-determined pressure. The pressure switch sends a signal to reverse valve 46 to begin a retraction cycle. At the same time, pressure switch signals an actuation of valve 52 to place delivery line 62 in communication with return line 64 and reservoir 40. The subsequent retraction of the compacting head and the return of fluid 64 occurs as described above in reference to trip switch 34. Pressure switch 56 will also switch the pump off when the compacting head is retracted.

Timer 70 reverses the cycle and switches valves 46 and 52 to retract compacting head 25 in the event pressure switch 56 fails to reverse the pump and start the retraction cycle.

While a preferred embodiment of the invention has been described using specific terms, such description is for illustrative purposes only, and it is to be understood that changes and variations may be made without departing from the spirit or scope of the following claims.

What is claimed is:

1. A split-trash compacting system for a vessel having a plurality of compartments comprising:
a trash compacting assembly disposed in a first compartment of the vessel readily accessible to persons on the vessel for receiving and compacting trash;
the trash compacting assembly including a trash bin for receiving trash, and a reciprocating compacting head carried above the trash bin for compacting trash in the trash bin, and
at least one fluid actuator unit for forcing the compacting head downward into the trash bin for compacting trash during a compaction cycle and retracting the compacting head during a retraction cycle;
a fluid actuating assembly disposed in a second compartment of the vessel remote from the trash compacting assembly for supplying pressurized fluid to the trash compacting assembly for actuating the fluid actuator unit;
at least one fluid line connecting the fluid actuator in the first compartment and the fluid actuating assembly in the second compartment; and
a fluid control circuit for controlling flow in the fluid line to reciprocate the compacting head during the compaction cycle and retraction cycle.

2. The system of claim 1 wherein said first compartment includes one of an interior cabin area and an exterior deck area of the vessel.

3. The system of claim 1 wherein the trash storage bin is carried on a sliding drawer which slides relative to the trash compacting head wherein the drawer has an open position for depositing trash in the trash bin and a closed position for compacting the trash in the trash bin.

4. The system of claim 1 wherein said at least one fluid actuator unit includes a first fluid actuator unit and a second fluid actuator unit, the fluid actuator units being connected to the compacting head for actuating the compacting head in the compaction and retraction cycles.

5. The system of claim 4 wherein said at least one fluid line includes a first fluid line connecting said first actuator unit and said fluid actuating assembly; and a second fluid line connecting said second fluid actuator and said fluid actuating assembly.

6. The system of claim 1 wherein said fluid control circuit includes a plurality of control valves and switches, and control wiring located at said fluid actuating system.

7. The system of claim 4 wherein said fluid actuating assembly includes a fluid pump connected to a source of motive fluid.

8. The system of claim 1 including a low voltage control switch disposed at the first location and operatively connected with the fluid control circuit for controlling the operation of the trash compacting assembly in the second compartment.

9. The system of claim 8 including and a low voltage control line connecting the switch at the first compartment to the fluid actuating assembly at the second compartment.

10. The system of claim 1 including a pressure switch operatively connected with the fluid control circuit for switching the fluid actuating assembly from the compaction cycle to the retraction cycle upon sensing a preset pressure level in the fluid line.

11. The system of claim 1 including a timer switch operatively connected with the fluid control circuit for controlling the operation of the fluid pump wherein the timer switch reverses the operation of the trash compacting assembly from a compaction cycle to a retraction cycle after a predetermined period of time.

12. A split-trash compacting system for a vessel comprising:
a trash compacting assembly disposed in a first area of the vessel readily accessible to persons for receiving and compacting trash;
the trash compacting assembly including a trash bin for receiving trash, and a reciprocating compacting head carried above the trash bin for compacting trash in the bin, and
at least one fluid actuator unit for forcing the compacting head downward into the trash bin for compacting trash during a compaction cycle and retracting the compacting head to a position above the trash bin during a retraction cycle;
a fluid actuating assembly disposed in a second area of the vessel remote from the first area for supplying pressurized fluid to the trash compacting assembly to actuate the fluid actuator unit;
at least one fluid line connecting the fluid actuator in the first area and the fluid actuating assembly in the remote second area; and
a fluid control circuit for controlling flow in the fluid line to reciprocate the compacting head during the compaction cycle and retraction cycle.

13. The system of claim 12 including a compartment at the second area in which the fluid actuating assembly is disposed and generally isolated from the other areas of the vessel.

14. The system of claim 12 wherein the trash storage bin is carried by a sliding drawer which slides relative to the trash compacting head wherein the drawer has an open position for depositing trash in the trash bin and a closed position for compacting the trash in the bin.

15. The system of claim 12 including a first fluid actuator unit and a second fluid actuator unit, the fluid actuator units being connected to the compacting head for actuating the compacting head in the compaction and retraction cycles.

16. The system of claim 12 wherein said fluid actuating assembly includes a fluid pump connected to a source of motive fluid.

17. The system of claim 16 including a low voltage control switch disposed at the first area and operatively connected with the fluid pump for controlling the operation of the pump, and a low voltage control line connecting the switch at the first area to the fluid pump at the second area.

18. The system of claim 16 including a pressure switch operatively connected with the fluid line for reversing the fluid pump from the compaction cycle to the retraction cycle upon sensing a preset pressure level in the fluid line.

19. The system of claim 16 including a timer switch operatively connected with the fluid pump for controlling the operation of the fluid pump wherein the timer switch reverses the operation of the fluid from a compaction cycle to a retraction cycle after a predetermined period of time.

20. A method of disposing of trash onboard a mobile transport vehicle comprising:
providing a trash compacting assembly at a first location readily accessible to persons on the vehicle for receiving and compacting trash wherein the trash compacting assembly includes a trash bin for receiving trash, and a reciprocating compacting head having a fluid actuator for compacting trash in the trash bin,
providing a fluid actuating assembly disposed in a second, generally isolated location remote from the trash compacting assembly for supplying pressurized fluid to the fluid actuator unit;
connecting the fluid actuator in the first location and the fluid actuating assembly in the second location with at least one fluid line; and
causing a fluid flow in the fluid line to reciprocate the compacting head in compaction and retraction cycles for compacting trash on board the vessel.

21. The method of claim 20 including locating the compacting assembly at one of an interior cabin area and an exterior deck area of the vessel.

22. The method of claim 20 including operating the trash compacting assembly with a low voltage switch, connecting the switch at the first location to the fluid actuating assembly at the second location with a low voltage control line.

23. The method of claim 20 including operatively connecting a pressure switch with the fluid control circuit for switching the fluid actuating assembly from the compaction cycle to the retraction cycle upon sensing a preset pressure level in the fluid line.

24. The method of claim 20 including operatively connecting a timer switch with the fluid control circuit for controlling the operation of the fluid pump wherein the timer switch switches the operation of the trash compacting assembly from a compaction cycle to a retraction cycle after a predetermined period of time.
